(19) United States
(12) Patent Application Publication
(10) Pub. No.: US 2026/0333392 A1
(43) Pub. Date: Oct. 22, 2026

(54) PHYSICAL CHANNEL STRUCTURE FOR SIDELINK (SL) IN UNLICENSED SPECTRUM

(71) Applicant: Apple Inc., Cupertino, CA (US)

(72) Inventors: Haitong Sun, Saratoga, CA (US); Chunxuan Ye, San Diego, CA (US); Hong He, San Jose, CA (US); Chunhai Yao, Beijing (CN); Wei Zeng, Saratoga, CA (US); Seyed Ali Akbar Fakoorian, San Diego, CA (US); Weidong Yang, San Diego, CA (US); Dawei Zhang, Saratoga, CA (US); Huaning Niu, San Jose, CA (US); Sigen Ye, San Diego, CA (US)

(21) Appl. No.: 19/112,290

(22) PCT Filed: Sep. 23, 2022
(86) PCT No.: PCT/CN2022/121096

§ 371 Date: Mar. 17, 2025

(51) Int. Cl. H04W 72/25; H04B 17/318

(52) U.S. Cl. CPC H04W 72/25; H04B 17/328

(57) ABSTRACT

A user equipment (UE) can operate in an unlicensed network for sidelink (SL) communications to generate a sidelink (SL) synchronization signal block (S-SSB) transmission in a new radio (NR) unlicensed band, wherein at least one physical resource block (PRB) can be added to satisfy a temporary exemption of an occupied channel bandwidth (OCB). The UE can transmit the S-SSB transmission in an SL channel of the unlicensed band.

### FIELD

The present disclosure relates to wireless technology including sidelink (SL) physical channel structure(s) in the unlicensed spectrum.

### BACKGROUND

Mobile communication in the next generation wireless communication system, 5G, or new radio (NR) network provides ubiquitous connectivity and access to information, as well as ability to share data, around the globe. 5G networks and network slicing is a unified, service-based framework that will target to meet versatile and sometimes, conflicting performance criteria to provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions. Another type of mobile communication includes vehicle communication, where vehicles communicate or exchange vehicle related information. The vehicle communication can include vehicle to everything (V2X) devices or a V2X user equipment (UE), which includes vehicle to vehicle (V2V), vehicle to infrastructure (V2I) and vehicle to pedestrian (V2P) where direct communication without a base station may be employed, such as in a sidelink (SL) communication.

In 3GPP, NR-based access to unlicensed spectrum has initiated. The NR system is designed to be operable on licensed spectrum. The NR-unlicensed (NR-U), a shorthand notation of the NR-based access to unlicensed spectrum, is a technology to enable the operation of NR system using unlicensed spectrum. The technologies for NR-unlicensed can be categorized into those to support carrier aggregation (CA), dual connectivity (DC), or sidelink (SL) communications and standalone modes of network operation.

### BRIEF DESCRIPTION OF THE DRAWINGS

FIG. 1 illustrates an exemplary block diagram illustrating an example of user equipment(s) (UEs) communicatively coupled with network components as peer devices useable in connection with various embodiments (aspects) described herein.

FIG. 2 illustrates an example system with a sidelink (SL) communication including an SL synchronization signal block (S-SSB) configuration in accordance with various aspects discussed herein.

FIG. 3 another example of sidelink (SL) communication including an S-SSB configuration in accordance with various aspects discussed herein.

FIG. 4 another example of sidelink (SL) communication including an S-SSB configuration in accordance with various aspects discussed herein.

FIG. 5 another example of sidelink (SL) communication including an S-SSB configuration in accordance with various aspects discussed herein.

FIG. 6 an example process flow of SL communication according to various aspects.

FIG. 7 illustrates another example process flow of SL communication according to various aspects.

FIG. 8 illustrates an example UE configuration for determining a transport block size (TBS) in SL communications according to various aspects.

FIG. 9 illustrates example of SL feedback configurations for SL communication according to various aspects.

FIG. 10 illustrates an example resource exclusion in co-channel coexistence for SL communication according to various aspects.

FIG. 11 illustrates an example resource exclusion in co-channel coexistence for SL communication according to various aspects.

FIG. 12 illustrates an example process flow of SL communication according to various aspects.

FIG. 13 illustrates an exemplary block diagram illustrating an example of UEs communicatively coupled a network with network components as peer devices useable in connection with various embodiments (aspects) described herein.

FIG. 14 illustrates another example process flow for SL communication according to various aspects.

FIG. 15 illustrates another example process flow of SL communication according to various aspects.

FIG. 16 illustrates another example process flow of SL communication according to various aspects.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects including a user equipment (UE) device operating in sidelink (SL) communication. The UE device selects and configures resources to enable SL communication as described herein. The UE device can be a pedestrian UE (P-UE) device, a vehicle-to-everything (V2X) device, or other UE that may include vehicle-to-vehicle (V2V), vehicle-to-infrastructure (V2I), vehicle-to-pedestrian (V2P) device communication, or other direct communication between UEs, which can comprise an SL communication. A UE when referred to herein can also further include a Roadside Unit (RSU), a drone, other vehicle device, Internet of Things (IoT) device, or other user equipment device, for example.

Regarding new radio (NR) SL on unlicensed spectrum, various aspects are described to include NR SL physical channel structures and processes for operating on the unlicensed spectrum in light of regulatory requirements. For example, with NR SL transmissions, consideration is being made for how to structure the NR SL physical channel configuration to satisfy occupied channel bandwidth (OCB) regulatory requirements, where a minimum transmission of 2 MHz is temporarily allowed as a temporary exemption. These OCB regulations include, for example, that the OCB, which is the bandwidth containing 99% of the power of the signal, should be 80% to 100% of the nominal channel bandwidth (NCB). In certain 5G NR instances, the nominal channel bandwidth (NCB) for a single operating channel is 20 MHz, so transmissions complying with the OCB regulations typically would occupy 16-20 MHz bandwidth. The OCB regulations, however, allow a temporary exemption where an OCB less than 80% of the NCB is permitted for transmissions in unlicensed spectrum, with a minimum bandwidth of 2 MHz.

Accordingly, whether or how a sidelink synchronization signal block (S-SSB) transmission can be configured to meet the minimum 2 MHz temporary exemption of the OCB regulatory requirement is described in the present disclosure. In some instances, the S-SSB transmission for NR includes at least a physical sidelink broadcast channel (PSBCH), a sidelink primary synchronization signal block (S-PSS), and a sidelink secondary synchronization signal (S-SSS). In legacy implementations, the S-SSB may occupy 11 PRBs at a subcarrier spacing of 15 kHz. At 180 KHz per PRB, the S-SSB transmission would occupy 1.98 MHz of bandwidth, which still remains 20 Hz less than the minimum 2 MHz for satisfying the temporary exemption. In various aspects, the UE can configure the S-SSB structure such that the minimum 2 MHz temporary exception is met, including adding at least one additional PRB.

When configuring a dedicated sidelink (SL) channel between UEs (e.g., V2X/V-UEs, or other UEs) in an out-of-coverage scenario or in an unlicensed NR network, an initiating/initiator UE senses the SL channel to determine whether it is busy or not, and upon acquiring the SL channel communication provides sidelink control information (SCI) in two stages. The first stage SCI can be carried on a physical sidelink control channel (PSCCH) and comprises information to enable sensing operations on the acquired SL channel, as well as information about the resource allocation. A physical sidelink shared channel (PSSCH) transmits the second stage SCI and an SL shared transport channel. The second stage SCI carries information to enable identification and decoding of the SL channel, as well as control for Hybrid Automatic Repeat Request (HARQ) procedures, and triggering for channel state information (CSI) feedback, or related information, including physical sidelink channel feedback (PSFCH). The physical SL shared channel (PSSCH) carries one or more transport blocks (TB) of data for SL transmission. The SCI includes information for the correct reception of the TB. Thus, various aspects being described enable and ensure that the TB of data in SL transmission by a receiving UE in an unlicensed NR network is decoded properly and the associated SCI is correctly received in SL communications.

For the UE receiving the S-SSB in SL communications on the unlicensed NR network, a clear channel assessment (CCA) or listen before talk (LBT) operation to ensure fair and efficient channel co-existence may be performed. In addition to the initial S-SSB occasion for S-SSB transmission in NR SL, additional candidate S-SSB occasions may be supported for (re) transmission based on the resource pool for PSSCH/PSCCH transmission. The UE behavior can be based on a resource pool (pre) configuration. When an additional S-SSB occasion does not belong to or is not supported by the resource pool for PSSCH/PSCCH transmission, transmissions on the PSSCH or PSCCH may not be enabled in additional candidate S-SSB occasions. When one or more additional S-SSB occasions are indicated or belong to the resource pool for PSSCH/PSCCH transmission and the S-SSB is successfully received in the initial S-SSB occasion, the receiving UE may not need to monitor the slot for the additional candidate S-SSB occasion for an additional S-SSB. In some instances, the slot for the additional candidate S-SSB occasion can be utilized for other PSSCH/PSCCH transmission in an example aspect.

Various aspects further consider determining the transport block size (TBS) for data SL transmission when utilizing interlaces for satisfying the OCB regulations in the SL. An SL interlace can have different sizes, or different numbers of physical resource blocks. As a result of the initial transmission and re-transmissions potentially having different numbers of physical resource blocks (PRBs) (e.g., 10 or 11 PRBs), an SL TBS may not be as reliable as possible, and may result in a potential inconsistency for the UE in calculating the TBS. Thus, various aspects include configuring the PRBs uniformly for the sake of reliability. The number of PRBs, for example, can be predefined, (pre) configured based on a resource pool for SL transmission, or be dynamically indicated by the control information, the SCI. Additionally, or alternatively, the intra-cell guard band may be utilized for PSSCH/PSCCH transmission, in which the PRBs in the intra-cell guard band may be counted, or not, in the TBS determination based on a predefined rule or a resource pool (pre) configuration (preconfigured or configured on the fly/dynamically).

In yet further aspects, the PSFCH transmissions in SL can also be configured to satisfy the OCB regulations by using one or more common PRBs, especially where each PSFCH transmission can occupy some dedicated PRBs and some common PRBs. Each UE can use a dedicated PRB to transmit hybrid automatic repeat request (HARQ) acknowledgement (ACK) information accordingly. The common PRBs can correspond to an entire interlace, or be configured as subset of an interlace for an associated PSSCH transmission. Further, the dedicated PRBs or feedback transmission can be (pre) configured or dynamically indicated according to the resource pool for SL transmission.

In addition, resource selection in SL communications for NR can consider co-channel coexistence when an NR SL resource selection procedure occurs during LTE resource reservations corresponding to the slot for the PSSCH to avoid any automatic gain control (AGC) issues in power or potential collision. In particular, when the NR feedback transmission overlaps a time slot with a subframe reserved for an LTE SL transmission, signal interference can result in a collision in transmission that disrupts the LTE SL transmission, especially where NR has a much greater power gain in AGC. In an aspect, the UE can operate to exclude certain resources in consideration of the LTE sidelink sensing results, or exclude performing the feedback transmission (e.g., PSFCH) itself. The UE can therefore prevent causing the feedback SL transmission when LTE reservations for the same resources are sensed.

In one aspect, a baseband processor or other processor of a UE can include a memory and processing circuitry communicatively coupled to the memory that enables SL communications in a new radio (NR) unlicensed network among UE devices. The processor or processing circuitry can be configured to generate an S-SSB transmission in an unlicensed band, wherein at least one PRB is added to satisfy a temporary exemption of an occupied channel bandwidth (OCB). The UE can then transmit the S-SSB transmission in an SL channel of the unlicensed band.

In another aspect, a UE can be configured to determine a sidelink transport block size (SL TBS) of an interlace for an initial data transmission and a data re-transmission with a number of PRBs based on being pre-defined, a resource pool (pre) configuration, or a dynamic indication in a stage one SL control information (SCI). The number of PRBs comprises 10 PRBs or 11 PRBs. These and other aspects are detailed below with reference to figures.

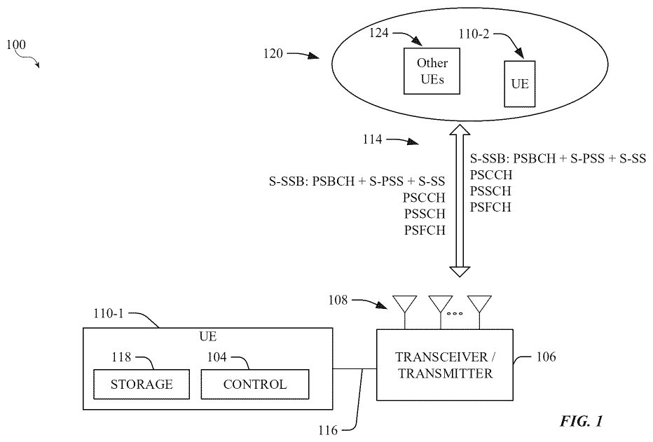

FIG. 1 is a diagram illustrating a system 100 for SL communications as direct communication via one or more UEs such as a pedestrian UE, a vehicle UE, or as other network device. The system 100 facilitates SL communications by enhancing reliability and accuracy to data during power saving procedures such as resource selection procedures, partial or reduced sensing operations, re-evaluation/pre-emption checking for transmissions in SL operation, and congestion control.

The system 100 includes a UE 110-1, a transceiver 106, and participant device entities 120, which can represent V-UEs (e.g., UEs 124), or any UE 110-2 operating on an unlicensed network or NR unlicensed network that could participate in SL communication as a direct communication with another UE or network device. The UE 110-1, for example, includes the transceiver 106, a storage component 118, and control circuitry or controller 104. The storage component 118 includes a memory, storage element or other data store configured to store information for the UE 110-1. The controller 104 is configured to perform various operations associated with the UE 110-1. The controller 104 can include logic, components, circuitry, one or more processors (baseband circuitry processors or other processing circuitry) for configuring SCI and SL communications. The transceiver 106 includes transmitter functionality and receiver functionality. The UE 110-1 also includes one or more antenna 108 for SL communications of an SL channel 114, which includes emergency services broadcast communications as well as SCI with the participant entities 120.

The participant device entities 120 include one or more other UEs 110-2, including infrastructure entities, vehicle entities, smart glass, and the like. The communications between the UE 110-1 and the participating device entities 120 includes Vehicle to Everything (V2X) devices, which further includes Vehicle to Vehicle (V2V), Vehicle to Infrastructure (V2I) and Vehicle to Pedestrian (V2P), and other network components or devices. The entities 120 can also include a road side unit (RSU), which is an entity that supports V2I and is implemented in a base station (e.g., gNB, eNB, etc.) or a stationary/non-stationary UE/IoT, for example.

The sidelink communications between the UE 110-1 and the participating device entities 120 can utilize co-operative awareness that includes information from other vehicles, sensors, and the like, to process and share the information to provide vehicle services such as collision warning, autonomous driving, and the like. SL communications can be between UEs that may be served by an evolved universal terrestrial access network (E-UTRAN) or where at least one of communicating UE may be out of network coverage for mode-2 SL communication or for operating in the NR unlicensed band, for example.

Additionally or alternatively, resource (re) selection procedure/operations can include a resource exclusion, an iterative formation of a candidate resource set, SL-received signal strength indicator (SL-RSSI) averaging of remaining resources, resource ranking and a randomized selection of resources from candidate resource set with minimum received energy. This can then be followed up with/preceded by and then sequentially repeated together with a sensing window/procedure to monitor the spectrum/medium/channels of communication by the UE and neighboring channels or communication devices detected according to aspects described herein.

In some aspects, when configuring a dedicated sidelink (SL) channel 114 between one or more UEs 110-2 (e.g., V2X/V-UEs, or other UEs 124) in an out-of-coverage scenario or in an unlicensed NR network, for example, the UE 110-1 can operate as the initiating/initiator UE, for example, by sensing the SL channel 114 to determine whether it is busy or not, and upon acquiring the SL channel communication provides SCI. A first stage of the SCI, stage 1, can be carried on the PSCCH with information to enable sensing operations on the acquired SL channel, as well as information about the resource allocation for feedback or PSFCH transmission. The PSSCH transmits the second stage SCI and an SL shared transport channel. The second stage SCI carries information to enable identification and decoding of the SL channel, as well as control for HARQ procedures, and triggering for CSI feedback, or related information, including PSFCH. The logics of NR SL is similar to LTE SL, however some degree of PHY layer modification is made, especially with physical channel design. Both UEs, UE 110-1 and 110-2, for example, can transmit the S-SSB, including PSBCH, S-PSS, and S-SSS for initiating SL communications and both UEs can schedule its own physical layer data, for example. The numerologies support by SL communications can have similar NR numerologies as shown below:

| μ | Δf = 2^{μ} [kHz] | Cyclic Prefix |
|---|---|---|
| 0 | 15 | Normal |
| 1 | 30 | Normal |
| 2 | 60 | Normal, Extended |
| 1 | 120 | Normal |

The second stage SCI of the PSCCH carries information to enable identification and decoding of the SL channel, as well as control for HARQ procedures, and triggering for CSI feedback, or related information, including PSFCH. The PSSCH carries a TB for of data for SL transmission on the PSSCH. The SCI can include resource information of resource pool(s) for the correct reception of the TB. Thus, various aspects being described enable and ensure that the TB of data in SL transmission by a receiving UE in an unlicensed NR network is decoded properly and the associated SCI is correctly received in SL communications.

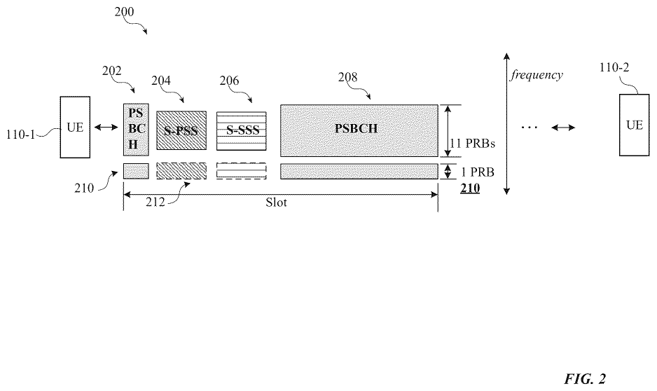

Referring to FIG. 2, illustrated is an example S-SSB structure 200 to satisfy a temporary OCB exemption in accord with various aspects. The S-SSB structure 200 can be an SL physical channel structure for NR SL unlicensed communication in light of regulatory requirements for a 15 kHz SCS, a 30 KHz SCS or both 15 kHz and 30 KHz SCS.

In particular, OCB regulatory requirements can demand that the power of a signal should be 80% or greater of the NCB at 20 MHz. A temporary exemption can be adopted for an OCB less than 80% of its NCB with a minimum of 2 MHz. However, the S-SSB transmission for NR includes 11 PRBs. At an SCS of 15 kHz with 180 kHz per PRB, the S-SSB transmission still remains 20 Hz less than the minimum of 2 MHz (at 1.98 MHz) for satisfying the temporary exemption.

In an aspect, the UE can configure the S-SSB structure with at least one additional PRB to satisfy this temporary exemption. For example, the S-SSB structure 200 can include a PSBCH 202 as one symbol, a S-PSS 204 as two symbols, a S-SSS 206 as two symbols, and PBSCH symbols 208 (e.g., 5 PBSCH symbols) for the remaining of eleven symbols, in which a gap symbol (not shown) can also be present.

In one example, in order to ensure the S-SSB structure satisfies the temporary exemption of OCB regulations one additional PRB 210 can be added in the frequency domain (vertical/y-axis plane), where the time domain may be the horizontal/x-axis plane and the frequency domain is perpendicular and vertical as illustrated. In this manner, the S-SSB 200 can be generated with 11 PRBs with an additional PRB 210 connected or contiguous along the frequency domain with the existing 11 PRB S-SSB. Any actual illustrated gaps between types of symbols as illustrated here are only for sake of illustration and otherwise may not be present.

In an aspect, the additional PRB 210 can be added only on symbols PSBCH 202 and 208, and be empty at the symbols 212 with a dashed line for the symbols connected with the S-PSS 204 and the S-SSS 206, so that the PRB 210 only spans the PSBCH 202 and 208. Alternatively, or additionally, the additional PRB 210 can span the full slot across the time domain for the S-SSB and include the symbols 212 with a dashed line for the S-PSS 204 and the S-SSS 206 spanning across. In other words, symbols 212 with dashed lines corresponding to S-PSS 204 and the S-SSS 206, respectively, can span both S-PSS 204 and the S-SSS 206 in the time domain, and the additional PRB 210 span the time domain of the S-SSB 200, including the PSBCH 202, S-PSS 203, S-SSS 206, PSBCH 208.

The contents of the additional PRB 210 can include the same content as a lowest or a highest PRB of a legacy S-SSB, or of the 11 PRBs that the additional PRB 210 is being added/connected to in the frequency domain, for example. Thus, the S-SSB 200 can be configured by adding another version of a PRB with same information, for example. Accordingly, when the additional PRB 210 includes only symbols associated with the PSBCH 202 and 208, then only one of these PRBs spanning PSBCH 202 and 208 could be a copy (e.g., the highest PRB, the lowest PRB for PSBCH 202 and 208 along the frequency domain, or other PRB copy that may not be the lowest or the highest).

Alternatively, or additionally, the contents of the additional PRB 210 can be the same as a resource pool (pre) configured PRB in a legacy SSB. The additional PRB 210 may or may not span the entire slot. A resource pool limits the radio resources for PSCCH and PSSCH since they cannot be transmitted in all resource blocks (RBs) and slots of NR, or even the frequency span of the NR SL. A resource pool can include the resource unite size, the time domain and frequency domain resources, as well as other resources for SL communication. The concept of resource pool can be also applied in autonomous resource allocation of UEs especially (e.g., mode 2 resource allocation) where resources are selected based on a sensing procedure on a specific resource pool. In the frequency domain, a resource pool is divided into sub-channels which are consecutive and non-overlapping PRBs (e.g., where the number of PRBs is ≥10). The size of a resource pool can be configured by higher layers or through signaling by a base station. Transmission and reception resource pools may be also configured in a UE separately.

Alternatively, or additionally, the contents of the additional PRB 210 can be comprised of dummy data. This dummy data can operate as a placeholder without significantly useful information, such as with zeros or other data. Alternatively, or additionally, the contents of the additional PRB 210 can be comprised of actual data of PSBCH. This implies the rate matching of PSBCH information to fill the additional PRB.

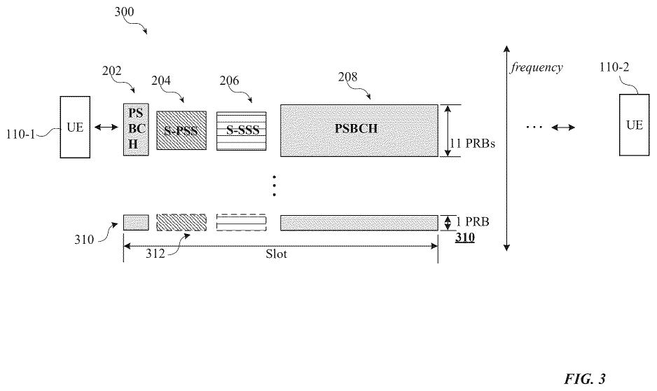

FIG. 3 illustrates another example of an S-SSB structure 300 to satisfy a temporary OCB exemption in accord with various aspects. S-SSB 300 can be an S-SSB configuration similar to S-SSB 200 of FIG. 2. Rather than the additional PRB 310 being generated as frequency domain connected to existing 11 PRB symbols to satisfy the temporary OCB exemption for a minimum transmission of 2 MHz, the additional PRB 310 can be configured at an edge of an RB set (e.g., a 20 MHz bandwidth). Rather than being contiguous with the 11 PRBs, the additional PRB 310 can be separate or contiguous in the frequency domain such as at an outer edge if the 11 PRBs (including PSBCH 202, S-PSS 204, S-SSS 205, PSBCH 208, etc.), either at the beginning or the end of an RB set, for example. An edge can correspond to a subset of a half of the RB set, for example, or a portion of the RB set that is less than half of the RB set and subset of contents form one side (e.g., a percent such as 30% or less or other portion of a first half of the RB set from its beginning, or an opposite second half to the RB set to its completion).

The contents of the additional PRB 310 can be configured as discussed above according to aspects of the additional PRB 210 of FIG. 2. For example, the contents of the additional PRB 310 can the same as a lowest or highest PRB in a legacy S-SSB or as a copy of a PRB in the 11 PRBs, the same as a resource pool (pre) configured PRB in the legacy S-SSB, or with dummy data. Likewise, the additional PRB 310 can include the dashed lined symbols 312 with the S-PSS 204 or S-SSS 206 to span the full or entire slot. Alternatively, or additionally, the additional PRB 310 can include only the symbols of the PSBCH 202 and 208 so as to not affect the S-PSS 204 or S-SSS 206 in any way.

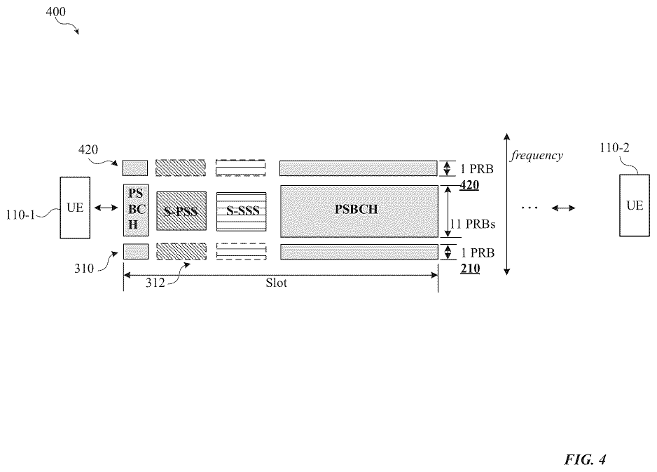

FIG. 4 illustrates another example of an S-SSB structure 400 to satisfy a temporary OCB exemption in accord with various aspects. Here, at least two PRBs can be added for the SL communication. In addition to the additional PRB 210 of FIG. 2 being added in a frequency domain connection or contiguous with the 11 PRBs, another PRB 420 can be added at the other side of the frequency domain of the 11 PRBs or on the same frequency side as the additional PRB 210, for example. The contents and structure of the another PRB 420 can be similar to or the same as PRB 210, for example.

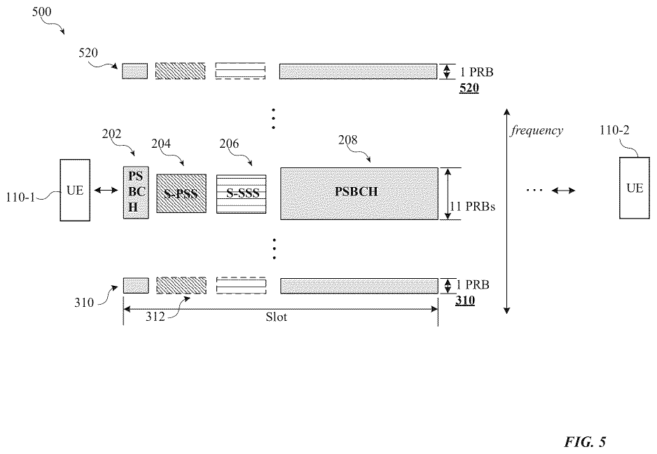

FIG. 5 illustrates another example of an S-SSB structure 400 to satisfy a temporary OCB exemption in accord with various aspects. Here, at least two PRBs can be added for the SL communication. In addition to the additional PRB 310 of FIG. 3 being configured at an edge of an RB set (e.g., 20 MHz) with the 11 PRBs, the another PRB 520 can be added at the other edge of an RB set. The contents and structure of the another PRB 520 can be similar to or the same as PRB 310, for example.

The aspects of FIG. 2-5 may or may not depend on the SCS. For example, the aspects of FIG. 2-5 can be applicable to only an SCS of 15 kHz, and not for 30 kHz, or applicable for both 15 kHz and 30 kHz, for example.

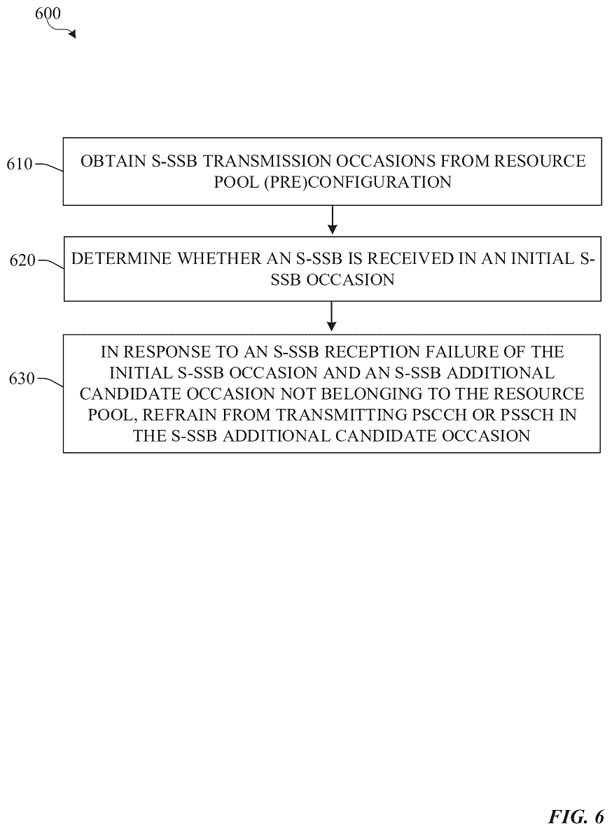

FIG. 6 illustrates an example process flow 600 that can be performed by a UE for S-SSB reception based on S-SSB additional candidate occasions. For the UE (e.g., UE 110-1, or 110-2) receiving the S-SSB in SL communications on the unlicensed NR network, additional candidate S-SSB occasions to the initial S-SSB occasion for S-SSB transmission may be supported based on the resource pool for PSSCH/PSCCH transmission. The UE behavior can be based on a resource pool (pre) configuration according to one or more resource pool parameters for synchronization signals for initiating SL communication.

The process flow 600 initiates at 610 with obtaining one or more S-SSB transmission occasions from a resource pool (pre) configuration. At 620, the process flow 600 includes determining whether an S-SSB is received in an initial S-SSB occasion for SL communications in the NR unlicensed band, for example. At 630, in response to an S-SSB reception failure, in which the S-SSB is not received in the initial S-SSB occasion, or an S-SSB additional occasion does not belong to, or is not indicated by, the resource pool, the UE refrains from transmitting PSCCH or PSSCH in the S-SSB additional candidate occasion.

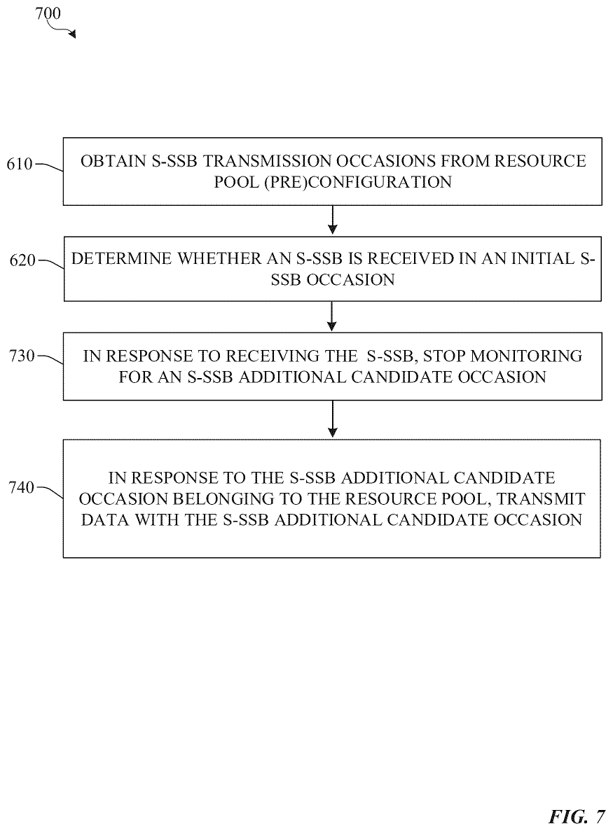

FIG. 7 illustrates another example process flow 700 that can be performed by a UE for S-SSB reception based on additional candidate S-SSB occasions belonging to or indicated by a resource pool. Process flow 700 is similar to process flow 600 of FIG. 6 until 730. At 730, process flow 700 includes in response to receiving the S-SSB in the initial S-SSB occasion, the UE stops monitoring for an S-SSB additional candidate occasion. At 740, in response the S-SSB additional candidate occasion belonging to or indicated by the resource pool, the UE transmits can transmit data (e.g., feedback, PSSCH, etc.) with the S-SSB additional candidate occasion.

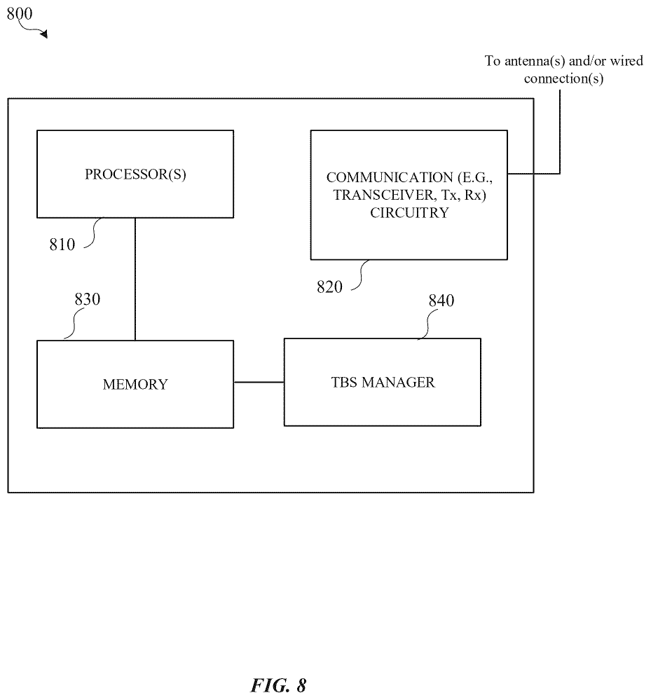

FIG. 8 illustrates is a block diagram of a UE device or another network device/component (e.g., V-UE/P-UE, IoT, base station (e.g., gNB, eNB, or the like), or other participating network entity/component) such as UE 110-1 or UE 110-2 for SL communications. The device 800 includes one or more processors 810 (e.g., one or more baseband processors) comprising processing circuitry, which can correspond to controller 104, for example. The device 800 further can comprise associated interface(s), transceiver circuitry 820 (e.g., comprising RF circuitry, which can comprise transmitter circuitry (e.g., associated with one or more transmit chains, as transceiver/transmitter 106) and/or receiver circuitry (e.g., associated with one or more receive chains) that can employ common circuit elements, distinct circuit elements, or a combination thereof), and a memory 830 (which can comprise any of a variety of storage mediums and can store instructions and/or data associated with one or more of processor(s) 810 or transceiver circuitry 820) as with storage 118 of FIG. 1. The UE 800 can also represent the UE 110-1 or 110-2, for example, further comprising a transport block size (TBS) manager component 840.

Memory 830 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection can also be termed a computer-readable medium.

Memory 830 can include executable instructions, and be integrated in, or communicatively coupled to, processor or processing circuitry 810. The executable instructions of the memory 830 can cause processing circuitry 810 receive or generate SCI in an NR unlicensed network. The SCI can include a first stage SCI on a PSCCH and a second stage SCI on a PSSCH. The first stage SCI or the second stage SCI can include COT indications that enable a sharing of an SL unlicensed channel acquired on an SL channel. The second stage SCI can include multiple slots of the PSSCH with different HARQ process Identifiers (HARQ IDs) corresponding to the multiple slots, respectively, or a same HARQ process ID for each slot, for example.

The TBS manager component 840 can be configured to calculate a transport block (TB) size (TBS) for a sidelink data channel transmission. An indication of the TBS size, for example, can then be communicated in the SCI to allow a receiving UE to determine the TBS used for decoding the SL communication. In the NR unlicensed spectrum interlaces could be 10 or 11 PRBs without consistency of sizes among interlaces. For example, with 15 kHz SCS five interlaces could be used for SL transmission, with the five interlaces having different numbers of PRBs (e.g., 10 or 11). For example, four interlaces could have 10 PRBs, while one has 11 PRBs. These different sizes or different number of PRBs means that in SL communications, the initial S-SSB transmission and re-transmission could have different interlaces with a different number of PRBs. The UE 800 (110-1, 110-2) could therefore be mismatched on the TBS size, which could result in difficulties for decoding the SL communication.

In an aspect, when interlacing is being used for SL communications and to satisfy the OCB regulations (e.g., 80% of bandwidth being used), the SL TBS determination may not be entirely reliable. Thus, the TBS manager component 840 can determine the sidelink TBS based on a number of PRBs in each interlace being pre-defined (e.g., 10 PRBs or 11 PRBs). For the TBS calculation the UE 800 (e.g., 110-1, 110-2) can assume each interlace has 10 or 11 PRBs as pre-defined.

Alternatively, or additionally, when interlacing is being used for SL communications and to satisfy the OCB, the TBS manager component 840 can determine the sidelink TBS based on a resource pool (pre) configuration. Here, when the resource pool (pre) configured 10 PRBs or 11 PRBs, then number of PRBs is used for calculating and determining the TBS.

Alternatively, or additionally, the number of PRBs to be used for the sidelink TBS determination can be dynamically indicated in the SCI (e.g., 10 or 11 PRBs). For example, the SCI stage 1 can be configured with a field to indicate the interlace size.

Alternatively, or additionally, when the resource pool for SL communication includes more than on RB set, then the UE 800 can determine that an intra-cell guard band is being used for the data or the control transmission (e.g., PSSCH or PSCCH) in the initial S-SSB transmission or additional SL re-transmission. In this case, the initial transmission may utilize the intra-cell guard band, but not the re-transmission, for example, which can guard against interference by separating radio bands with an unused part or gap, for example. As such, this may lead to different SL TB size determinations also. In an aspect, the TBS manager component 840 can determine the TBS by additionally or alternatively to the above aspects utilizing the number of PRBs in the intra-cell guard band. The TBS manager component 840 can calculate the TBS as a function of or based on the number of PRBs in the intra-cell guard.

Alternatively, or additionally, the TBS manager 840 can determine the sidelink TBS based on a resource pool (pre) configuration of whether and how many PRBs exist in an intra-cell guard band. The resource pool (pre) configuration can indicate whether an intra-cell guard band is being used for SL communication, as well as the number of PRBs used in the intra-cell guard band if used. This information can then be used to calculate the TBS.

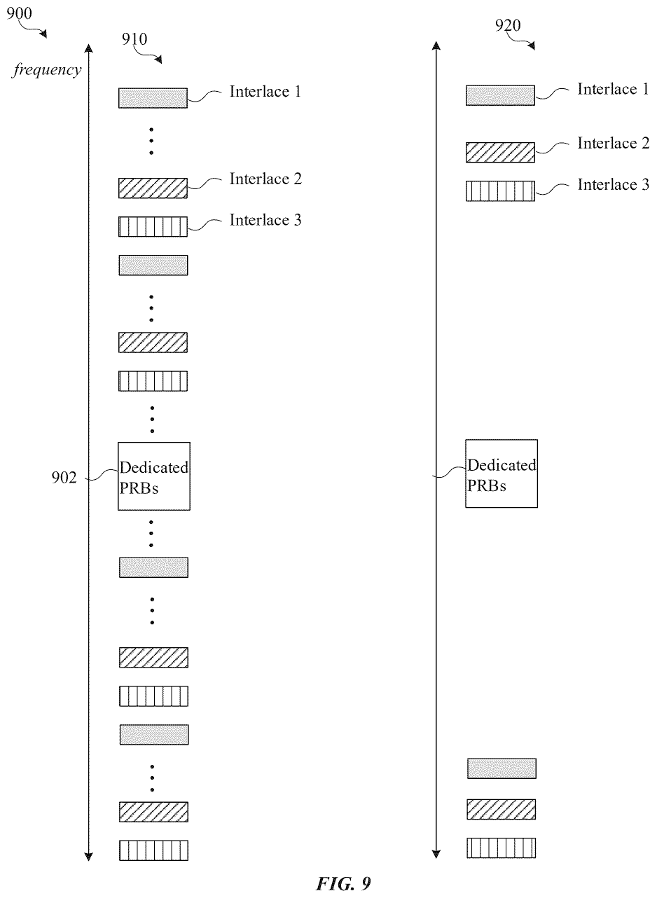

FIG. 9 illustrates an example of PSFCH transmissions 900 for SL communications in accord with the various PSFCH transmission configurations 910 and 920. Each PSFCH transmission can occupy both dedicated PRBs 902 for a carrier cell and common PRBs as the shaded or dashed blocks corresponding to similar interlace parts (1, 2, and 3) accordingly. Each interlace part (1, 2, 3) could be two symbols in the time domain, for example.

The PSFCH can carry HARQ-ACK or NACK information using two symbols, for example, in one carrier cell. Each PSFCH transmission example 910 and 920 can thus include two symbols in the time domain. One or more dedicated PRBs 902 as a set of PRBs can be used for the actual PSFCH information transmissions. The dedicated PRBs can be indicted by a bitmap that maps their locations, for example. Frequency domain resources for the actual PSFCH information transmission can be an integer multiple of the number of interlaces in an RB set (e.g., 20 MHz). The PSSCH transmission resources and associated PSFCH resources can be in a same RB set even when the resource pool includes multiple RB sets.

Each UE can use a PRB in a dedicated PRB set 902 to transmit the HARQ-ACK information. The PSFCH transmission has to satisfy the OCB, and so has to occupy 80% of the total resource. The dedicated PRBs illustrated in the middle of the RB set could be located anywhere therein, not just the middle part as illustrated for example, and serve to transmit the ACK/NACK information by including common PRBs with some additional information, such as dummy data, or a copy of its information in its associated interlaces. Thus, each UE uses one PRB in the dedicated PRB set to transmit the actual information, and then according to various aspects uses the interlace parts (1, 2, 3), or the common PRBs for the transmission to satisfy the OCB.

The common PRBs of example 910 and 920 can correspond to an interlace for an associated PSSCH transmission with different interlace parts 1, 2, 3 without including the parts corresponding to or including the dedicated PRBs 902. In example PSFCH transmission 910, a receiving UE of SL communications can use interlace part 3 in the frequency domain to transmit PSFCH and occupy the OCB, or as in example PSFCH transmission 920 could just use the edge part of the PRB, but does not use the middle part of the interlace part for the transmission in order to occupy or meet the OCB requirement. Because the UE is transmitting using the interlace part 3 for example 80% of the total bandwidth for OCB is satisfied. The PSFCH transmission does not transmit in the middle of the bandwidth but here it transmits at the edge of the bandwidth to meet the OCB requirement, where the actual transmission of the feedback is in the dedicated PRB domain 902. As such, the common PRBs can correspond to an interlace for the associated PSSCH transmission, or a subset or portion of an interlace at an edge of the bandwidth for the associated PSSCH transmission.

Alternatively, or additionally, whether this time and frequency PSFCH resource is (pre) configured or dynamically indicated can be based on the resource pool (pre) configuration. If the time and frequency PSFCH resources are indicated based on the resource pool (pre) configuration, then the UE can apply the indicated the PSFCH configuration schemes 910 or 920, for example. If no dedicated time and frequency PSFCH resources are indicated based on the resource pool (pre) configuration, then the dynamically indicated interlace transmission of the PSFCH could be transmitted as feedback.

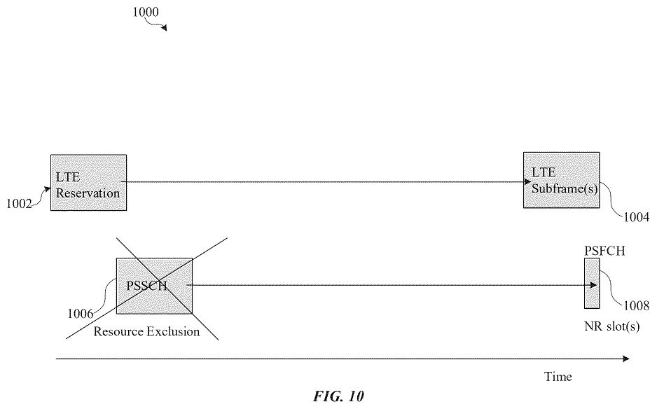

FIG. 10 illustrates an example of resource selection operations 1000 for co-channel coexistence in NR SL communications with unlicensed, licensed bands or both by taking into account LTE SL sensing results. Resource selection operations 1000 can be configured for NR SL resource pools with 15 kHz SCS, for example, or other SCS. In particular, where NR PSFCH is configured, the UE can operate to avoid PSFCH transmission in time slots that overlap with subframes being used or reserved for LTE transmission. The avoidance of PSFCH transmission 1008 can be performed by the UE transmitting the PSFCH 1008, the UE transmitting the PSSCH 1006, or both UEs, for example.

In particular, in co-channel coexistence where the LTE and NR SL share the resource pool because of the NR SL operations the feedback channel (PSFCH), which is at the end of each slot and could affect the LTE resource pool, or LTE slot because the automatic gain control (AGC) will be different causing power issues or collision.

For example, the LTE reservation 1002 could reserve the LTE subframe(s) 1004 that correspond to the NR slots for the NR PSFCH 1008 such that if the NR SL provides the feedback transmission, then the LTE SL would be affected by the sudden increase in signal power, even at the neighbor frequency domain or neighbor sub-channels.

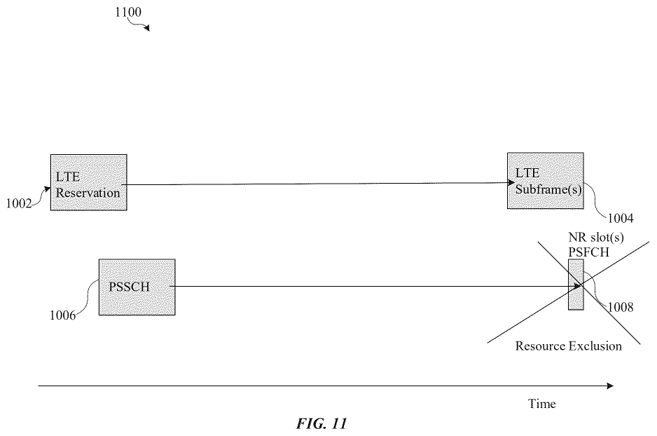

In an aspect, the UE (e.g., 800, 110-1, 110-2) could avoid causing the feedback transmission by not transmitting the feedback 1008 directly as illustrated in FIG. 11 with resource selection operations 1100. Here, the data channel or PSSCH 1006 may be transmitted, but the feedback is not transmitted because it may be determined that a collision or some AGC issue with LTE transmission may occur. Thus, if co-channel existence applies between LTE SL and NR SL and the NR PSFCH transmission is on a slot with time overlap with the LTE SL transmission (from another UE or not), then regardless of the priority of the NR SL PSFCH and the LTE sidelink PSSCH, the NR PSFCH will be excluded or skipped. Alternatively, or additionally, if the priority of the NR PSFCH is higher than the priority of the LTE SL PSSCH, the NR PSFCH is transmitted; otherwise, NR PSFCH is not transmitted.

Alternatively or additionally, as illustrated with FIG. 10 once the UE performs the resource selection of the data channel, which corresponds to the PSFCH transmission in a subframe with the LTE transmission, the UE does not transmit the data or PSSCH 1006 if determined to potentially overlap with the subframe s1004 because doing so may cause some AGC issue for the LTE sidelink reservation 1002 at LTE subframes 1004. Then the corresponding PSFCH 1008 for NR SL would not be transmitted. Correspondingly, the UE refrains from selecting the resources of the NR SL for PSSCH transmission 1006 for the feedback in this subframe 1004, and the UE excludes this slot in resource selection for the NR SL.

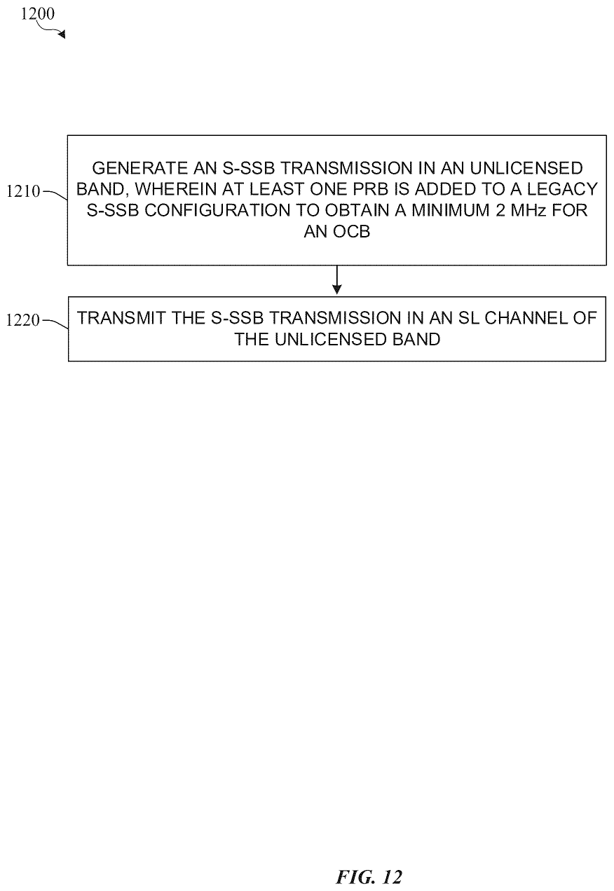

FIG. 12 illustrates an example process flow 1200 for SL communications to satisfy an OCB regulation in accord with various aspects. The process flow 1200 begins at 1210 with generating an S-SSB transmission in an unlicensed band (NR unlicensed band), wherein at least one PRB is added to satisfy a temporary exemption of an OCB. At 1220, the process flow 1200 further includes transmitting the S-SSB transmission in an SL channel of the unlicensed band.

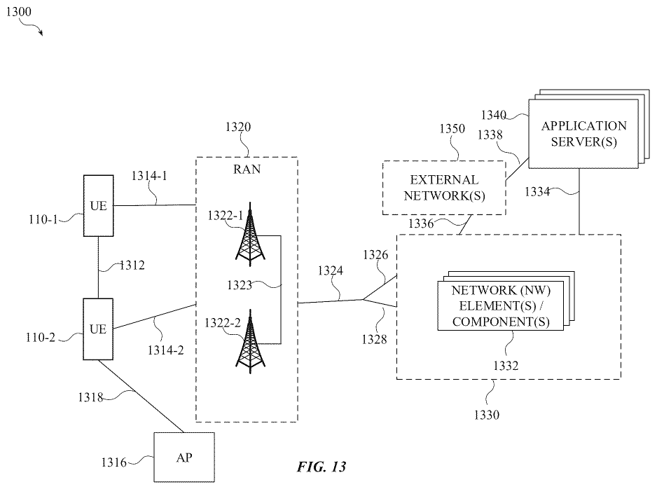

FIG. 13 is an example network 1300 according to one or more implementations described herein. Example network 1300 can include UEs 110-1, 110-2, etc. (referred to collectively as “UEs 110” and individually as “UE 110”), a radio access network (RAN) 13320, a core network (CN) 1330, application servers 13340, or external networks 1350.

The systems and devices of example network 1300 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1300 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 can include smartphones (e.g., handheld touchscreen mobile computing devices connectable to one or more wireless communication networks). Additionally, or alternatively, UEs 110 can include other types of mobile or non-mobile computing devices capable of wireless communications, such as personal data assistants (PDAs), pagers, laptop computers, desktop computers, wireless handsets, etc. In some implementations, UEs 110 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Additionally, UEs 110 can be NTN UEs that are capable of being communicatively coupled to satellites in an NTN network.

UEs 110 can communicate and establish a connection with (be communicatively coupled to) RAN 13320, which can involve one or more wireless channels 1314-1 and 1314-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 13322-1 and 13322-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 1330. Additionally, at least one of the MN or the SN can be operated with shared spectrum channel access, and functions specified for UE 110 can be used for an integrated access and backhaul mobile termination (IAB-MT). Similar for UE 110, the IAB-MT can access the network using either one network node or using two different nodes with enhanced dual connectivity (EN-DC) architectures, new radio dual connectivity (NR-DC) architectures, or other direct connectivity such as a sidelink (SL) communication channel as an SL interface 1312.

In some implementations, a base station (as described herein) can be an example of network node 1322. As shown, UE 110 can additionally, or alternatively, connect to access point (AP) 1316 via connection interface 1318, which can include an air interface enabling UE 110 to communicatively couple with AP 1316. AP 1316 can comprise a wireless local area network (WLAN), WLAN node, WLAN termination point, etc. The connection 1318 can comprise a local wireless connection, such as a connection consistent with any IEEE 702.11 protocol, and AP 1316 can comprise a wireless fidelity (Wi-Fi®) router or other AP. AP 1316 could be also connected to another network (e.g., the Internet) without connecting to RAN 13320 or CN 1330.

RAN 13320 can also include one or more RAN nodes 13322-1 and 13322-2 (referred to collectively as RAN nodes 1322, and individually as RAN node 1322) that enable channels 1314-1 and 1314-2 to be established between UEs 110 and RAN 13320. RAN nodes 1322 can include network access points configured to provide radio baseband functions for data or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1322 can include a roadside unit (RSU), a transmission reception point (TRxP or TRP), and one or more other types of ground stations (e.g., terrestrial access points). In some scenarios, RAN node 1322 can be a dedicated physical device, such as a macrocell base station, or a low power (LP) base station for providing femtocells, picocells or other like having smaller coverage areas, smaller user capacity, or higher bandwidth compared to macrocells.

Some or all of RAN nodes 1322 can be implemented as one or more software entities running on server computers as part of a virtual network, which can be referred to as a centralized RAN (CRAN) or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 1322; a media access control (MAC)/physical (PHY) layer split wherein RRC, PDCP, radio link control (RLC), and MAC layers can be operated by the CRAN/vBBUP and the PHY layer can be operated by individual RAN nodes 1322; or a “lower PHY” split wherein RRC, PDCP, RLC, MAC layers and upper portions of the PHY layer can be operated by the CRAN/vBBUP and lower portions of the PHY layer can be operated by individual RAN nodes 1322. This virtualized framework can allow freed-up processor cores of RAN nodes 1322 to perform or execute other virtualized applications.

In some implementations, an individual RAN node 1322 can represent individual gNB-distributed units (DUs) connected to a gNB-control unit (CU) via individual F1 interfaces. In such implementations, the gNB-DUs can include one or more remote radio heads or radio frequency (RF) front end modules (RFEMs), and the gNB-CU can be operated by a server (not shown) located in RAN 13320 or by a server pool (e.g., a group of servers configured to share resources) in a similar manner as the CRAN/vBBUP. Additionally, or alternatively, one or more of RAN nodes 1322 can be next generation eNBs (i.e., gNBs) that can provide evolved universal terrestrial radio access (E-UTRA) user plane and control plane protocol terminations toward UEs 110, and that can be connected to a 5G core network (5GC) 1330 via an NG interface.

Any of the RAN nodes 1322 can terminate an air interface protocol and can be the first point of contact for UEs 110. In some implementations, any of the RAN nodes 1322 can fulfill various logical functions for the RAN 13320 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 1322 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations can not be limited in this regard. The OFDM signals can comprise a plurality of orthogonal subcarriers.

Further, RAN nodes 1322 can be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can include channels that operate in a frequency range (e.g., approximately 400 MHz to approximately 3.8 GHZ, or other range). In some regions, the unlicensed spectrum can include about the 5 GHz band, for example, or other frequency bands. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 1322 can operate using licensed assisted access (LAA), eLAA, and/or feLAA mechanisms. In these implementations, UEs 110 and the RAN nodes 1322 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol or a clear channel assessment (CCA).

A physical downlink shared channel (PDSCH) can carry user data and higher layer signaling to UEs 110. The physical downlink control channel (PDCCH) can carry information about the transport format and resource allocations related to the PDSCH channel, among other things. The PDCCH can also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) can be performed at any of the RAN nodes 1322 based on channel quality information fed back from any of UEs 110. The downlink resource assignment information can be sent on the PDCCH used for (e.g., assigned to) each of UEs 110.

The PDCCH uses control channel elements (CCEs) to convey the control information, wherein a number of CCEs (e.g., 6 or the like) can consists of a resource element groups (REGs), where a REG is defined as a physical resource block (PRB) in an OFDM symbol. Before being mapped to resource elements, the PDCCH complex-valued symbols can first be organized into quadruplets, which can then be permuted using a sub-block interleaver for rate matching, for example. Each PDCCH can be transmitted using one or more of these CCEs, where each CCE can correspond to nine sets of four physical resource elements known as REGs. Four quadrature phase shift keying (QPSK) symbols can be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, 8, or 16).

The RAN nodes 1322 or RAN 13320 can be configured to communicate with one another via interface 13323. In implementations where the system is an LTE system, interface 13324 can be an X2 interface. The X2 interface can be defined between two or more RAN nodes 1322 (e.g., two or more eNBs/gNBs or a combination thereof) that connect to evolved packet core (EPC) or CN 1330, or between two eNBs connecting to an EPC. In some implementations, the X2 interface can include an X2 user plane interface (X2-U) 13326 and an X2 control plane interface (X2-C) 13328. The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

Alternatively, or additionally, RAN 13320 can be also connected (e.g., communicatively coupled) to CN 1330 via a Next Generation (NG) interface as interface 13324. The NG interface 13324 can be split into two parts, a Next Generation (NG) user plane (NG-U) interface 13326, which carries traffic data between the RAN nodes 1322 and a User Plane Function (UPF), and the S1 control plane (NG-C) interface 13328, which is a signaling interface between the RAN nodes 1322 and Access and Mobility Management Functions (AMFs).

CN 1330 can comprise a plurality of network elements 1332, which are configured to offer various data and telecommunications services to customers/subscribers (e.g., users of UEs 110) who are connected to the CN 1330 via the RAN 13320. In some implementations, CN 1330 can include an evolved packet core (EPC), a 5G CN, and/or one or more additional or alternative types of CNs. The components of the CN 1330 can be implemented in one physical node or separate physical nodes including components to read and execute instructions from a machine-readable or computer-readable medium (e.g., a non-transitory machine-readable storage medium).

As shown, CN 1330, application servers 13340, and external networks 1350 can be connected to one another via interfaces 1334, 1336, and 1338, which can include IP network interfaces. Application servers 13340 can include one or more server devices or network elements (e.g., virtual network functions (VNFs) offering applications that use IP bearer resources with CN 1330 (e.g., universal mobile telecommunications system packet services (UMTS PS) domain, LTE PS data services, etc.). Application servers 13340 can also, or alternatively, be configured to support one or more communication services (e.g., voice over IP (VOIP sessions, push-to-talk (PTT) sessions, group communication sessions, social networking services, etc.) for UEs 110 via the CN 1330. Similarly, external networks 1350 can include one or more of a variety of networks, including the Internet, thereby providing the mobile communication network and UEs 110 of the network access to a variety of additional services, information, interconnectivity, and other network features.

Various aspects herein can include the UE 110-1 communicating in SL communication over the SL interface 1312 (or channel) with peer UE 110-2, for example. In an aspect, UE 110-1 can communicate in SL communication to UE 110-2 over SL interface 1312. Processing circuitry of the UE 110-1 can execute instructions to cause the UE to generate an S-SSB transmission (e.g., in an NR unlicensed band), wherein at least one PRB is added to satisfy a temporary exemption of an OCB. The UE 110-1 can then transmit the S-SSB transmission in an SL channel of the unlicensed band.

The UE 110-1 or 110-2 is configured to process, perform, generate, communicate or cause execution of any one or more combined aspects described herein or in association with FIG. 1 thru FIG. 13.

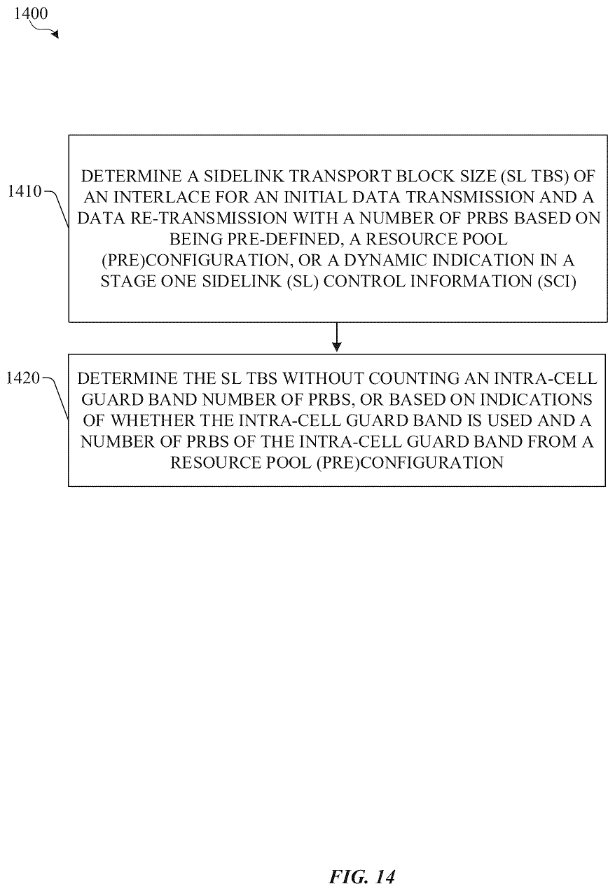

FIG. 14 illustrates an example process flow 1400 for determining an SL TBS by a UE communicating SL data with the TBS manager 840 of FIG. 8. The process flow initiates at 1400 with determining an SL TBS of an interlace for an initial data transmission and a data re-transmission with a number of PRBs based on being either pre-defined, based on a resource pool (pre) configuration, or a dynamic indication in a stage one sidelink (SL) control information (SCI). The number of PRBs can comprise 10 PRBs or 11 PRBs, for example. At 1420, the process flow 1400 can further include determining the TB size based on either not counting an intra-cell guard band number of PRBs in the determination, or based on indications of whether an intra-cell guard band is utilized in an RB set of resource and the number of PRBs used for the intra-cell guard band set from a resource pool (pre) configuration.

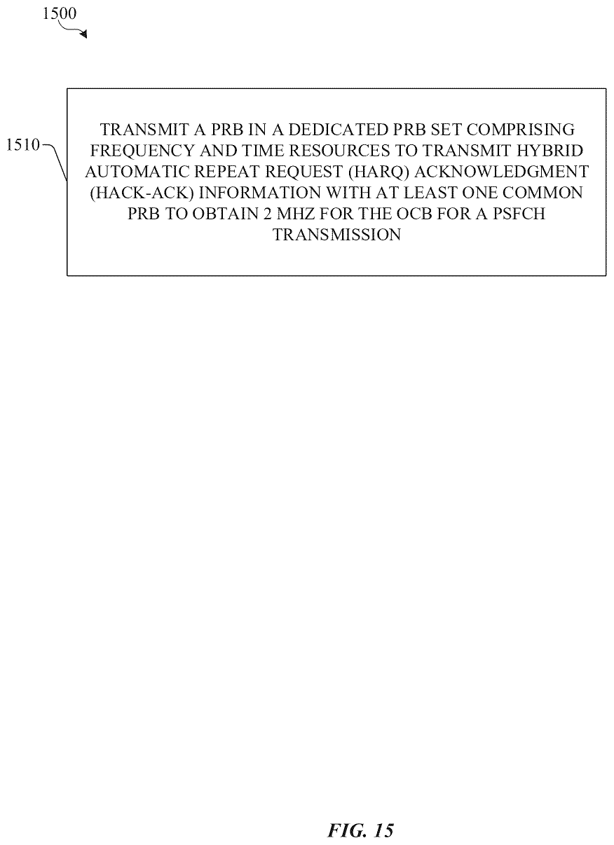

FIG. 15 illustrates an example process flow 1500 to obtain a 2 MHz for the OCB for a PSFCH transmission. The process flow 1510 comprises transmitting a PRB in a dedicated PRB set comprising frequency and time resources to transmit hybrid automatic repeat request (HARQ) acknowledgment (HACK-ACK) information with at least one common PRB to obtain 2 MHz for the OCB for a physical sidelink feedback channel (PSFCH) transmission. The at least one common PRB corresponds to an interlace or a subset of the interlace for an associated PSSCH transmission. The interlace used for the common PRB does not include a portion corresponding to a set of dedicated PRBs. The dedicated PRB set can be (pre) configured based on a resource pool or dynamically indicated to include the at least one common PRB.

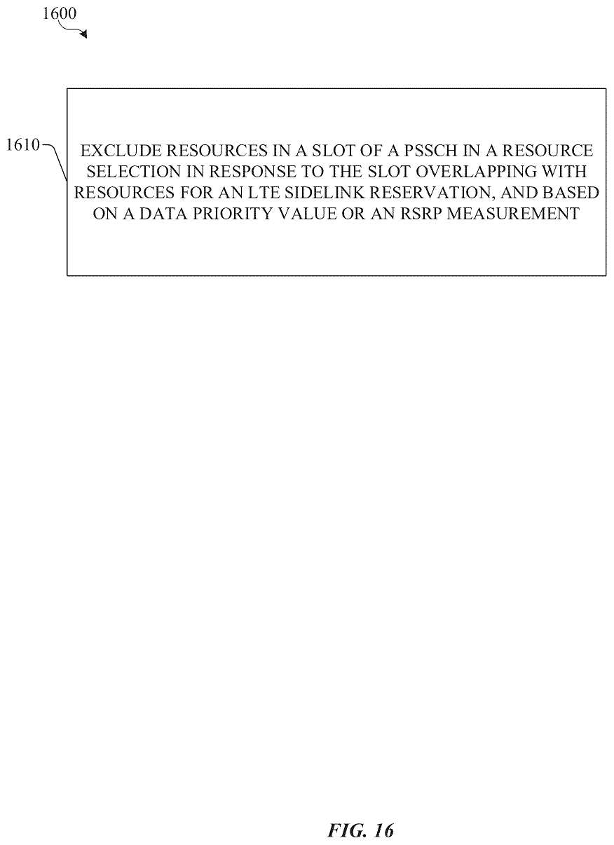

FIG. 16 illustrates an example process flow 1600 for excluding resources in case of an overlap of resources sensed from an LTE SL transmission reservation in accordance with aspects herein. At 1600, the resources in a slot of a PSSCH can be excluded in a resource selection in response to the slot overlapping with resources of an LTE sidelink reservation, and based on a data priority value of the LTE sidelink reservation corresponding to a high priority or satisfying a priority threshold or an RSRP measurement of the LTE sidelink reservation being above a predefined threshold/resource pool (pre) configured threshold.

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure is described with reference to attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1. A User Equipment (UE) comprising:
a memory;
processing circuitry, coupled to the memory, configured to, when executing instructions stored in the memory, cause the UE to:
generate a sidelink synchronization signal block (S-SSB) in an unlicensed band; and
transmit the S-SSB in a sidelink channel of the unlicensed band.

2. The UE of claim 1, wherein the S-SSB is 12 PRBs or 13 PRBs.

3. The UE of claim 2, wherein at least one PRB is located at one or more edges of a resource block (RB) set for the S-SSB.

4. The UE of claim 3, wherein the at least one PRB includes a duplicate content of another PRB for the S-SSB or dummy data.

5. The UE of claim 3, wherein the at least one PRB comprises only symbols of a physical sidelink broadcast channel (PSBCH) of the S-SSB or an entire slot including symbols of a sidelink primary synchronization signal (S-PSS), a sidelink secondary synchronization signal (S-SSS), and the PSBCH, and generating of the S-SSB is based on a subcarrier spacing (SCS) of 15 kHz, or 15 kHz and 30 KHz.

6. The UE of claim 1, wherein the processing circuitry is further configured to:
obtain one or more S-SSB transmission occasions from a resource pool (pre) configuration;
determine whether an S-SSB is received in an initial S-SSB occasion; and
in response to receiving the S-SSB in the initial S-SSB occasion, stop monitoring for an S-SSB additional candidate occasion; and
in response to the S-SSB additional candidate occasion belonging to the resource pool (pre) configuration, transmit a data transmission with the S-SSB additional candidate occasion.

7. The UE of claim 1, wherein the processing circuitry is further configured to:
determine a sidelink transport block size (SL TBS) of an interlace for the SSB with a number of PRBs based on a resource pool (pre) configuration.

8. The UE of claim 7, wherein the processing circuitry is further configured to:
determine the SL TBS without counting an intra-cell guard band number of PRBs, or based on indications of whether and how many of the intra-cell guard band number of PRBs from a resource pool (pre) configuration.

9. The UE of claim 2, wherein the processing circuitry is further configured to:
transmit a PRB in a dedicated PRB set comprising frequency and time resources to transmit hybrid automatic repeat request (HARQ) acknowledgment (HACK-ACK) information with at least one common PRB to obtain 2 MHz for an occupied channel bandwidth (OCB) for a physical sidelink feedback channel (PSFCH) transmission, wherein the at least one common PRB corresponds to an interlace or a subset of the interlace for an associated PSSCH transmission, and wherein the interlace does not include a set of dedicated PRBs, and wherein the dedicated PRB set is (pre) configured based on a resource pool or dynamically indicated to include the at least one common PRB.

10. The UE of claim 1, wherein the processing circuitry is further configured to: exclude resources in a slot of a PSSCH in a resource selection procedure in response to a resource reservation in the slot being from a long term evolution (LTE) sidelink that is sharing new radio (NR) PSFCH resources corresponding to the slot, and in response to the resource reservation comprising a data priority value above a threshold or a reference signal received power (RSRP) measurement of the resource reservation satisfies an RSRP threshold.

11. A method comprising:
generating, via processing circuitry, a sidelink synchronization signal block (S-SSB) transmission in an unlicensed band; and
transmitting the S-SSB in a sidelink channel of the unlicensed band.

12. The method of claim 11, wherein the S-SSB includes an S-SSB configuration with a subcarrier spacing (SCS) of 15 kHz or 30 KHz.

13. The method of claim 11, wherein the S-SSB includes 12 or 13 PRBs contiguously arranged in frequency domain, or includes at least one PRB located at one or more edges of a resource block (RB) set, and wherein the at least one PRB comprises only symbols of a physical sidelink broadcast channel (PSBCH) of the S-SSB or an entire slot including symbols of a sidelink primary synchronization signal (S-PSS), a sidelink secondary synchronization signal (S-SSS), and the PSBCH.

14. The method of claim 11, further comprising:
in response to an S-SSB reception failure of an initial S-SSB occasion and an S-SSB additional candidate occasion not belonging to a resource pool for a physical sidelink control channel (PSCCH) transmission or a physical sidelink shared channel (PSSCH) transmission, refraining from transmitting the PSCCH or PSSCH in the S-SSB additional candidate occasion.

15. The method of claim 11, further comprising:
determining a sidelink transport block size (SL TBS) of an interlace of the SSB with a number of PRBs based on, a resource pool (pre) configuration.

16. The method of claim 11, further comprising:
transmitting a hybrid automatic repeat request (HARQ) acknowledgment (HACK-ACK) information in a dedicated PRB set to transmit with at least one common PRB OCB for a physical sidelink feedback channel (PSFCH) transmission, wherein the at least one common PRB corresponds to an interlace or a subset of the interlace for an associated PSSCH transmission.

17. The method of claim 11, further comprising:
in response to an LTE resource reservation comprising a data priority value above a threshold or a reference signal received power (RSRP) measurement of a resource reservation satisfying an RSRP threshold, excluding resources in a slot of a corresponding PSSCH in a resource selection procedure, wherein the LTE resource reservation is from a long term evolution (LTE) sidelink that shares new radio (NR) PSFCH resources.

18. A baseband processor comprising:
a memory;
processing circuitry, communicatively coupled to the memory, configured to, when executing instructions stored in the memory, cause the baseband processor to:
generate a sidelink synchronization signal block (S-SSB) in an unlicensed band; and
transmit the S-SSB in a sidelink channel of the unlicensed band.

19. The baseband processor of claim 18, wherein the S-SSB includes at least 12 physical resource blocks (PRBs) to obtain a minimum of 2 MHz for an occupied channel bandwidth (OCB), and wherein at least one PRB of the at least 12 PRBs is located at one or more edges of a resource block (RB) set.

20. The baseband processor of claim 18, wherein the processing circuitry is further configured to determine a sidelink transport block size (SL TBS) of an interlace for an initial data transmission and a data re-transmission with a number of PRBs based on a resource pool (pre) configuration.

21-24. (canceled)
